(19) United States
(12) Patent Application Publication
(10) Pub. No.: US 2024/0394582 A1
(43) Pub. Date: Nov. 28, 2024

(54) PICKING COMPATIBLE ANNEALERS BASED ON THE MINOR EMBEDDING FEASIBILITY OF QUANTUM UNCONSTRAINED BINARY OPTIMIZATION MATRIX

(71) Applicant: Dell Products L.P., Round Rock, TX (US)

(72) Inventors: Rômulo Teixeira de Abreu Pinho, Niteroi (BR); Brendan Burns Healy, Haddonfield, NJ (US); Miguel Paredes Quiñones, Campinas (BR)

(21) Appl. No.: 18/321,258

(22) Filed: May 22, 2023

(51) Int. Cl. G06N 10/60; G06N 5/04

(52) U.S. Cl. CPC G06N 10/60; G06N 5/04

(57) ABSTRACT

Selecting quantum annealers that are compatible with a quantum job. A matrix associated with a quantum job is input to a prediction engine that is configured to infer whether a quantum annealer is compatible with the quantum job. The quantum annealer is compatible when a minor embedding operation can be performed to map a matrix graph to the hardware. This allows a quantum annealer to be selected for the quantum job efficiently and without having to perform the minor embedding operation to determine compatibility.

### FIELD OF THE INVENTION

Embodiments of the present invention generally relate to executing quantum jobs. More particularly, at least some embodiments of the invention relate to systems, hardware, software, computer-readable media, and methods for selecting quantum systems, such as quantum annealers, that are compatible with a quantum job based on matrix density levels of the quantum job.

### BACKGROUND

Quantum computing systems/devices, such as a quantum annealers, can often solve problems more quickly and efficiently than classical computing systems. For example, quantum annealers perform well when solving optimization or combinatorial problems. More specifically, for an optimization problem that has a very large solution space, a quantum annealer can often find a suitable solution more quickly than classical computing systems.

However, the physical construction of a quantum annealer (or other quantum system) imposes restrictions on how its qubits are physically connected. Sometimes, very few qubit-qubit connections exist in the quantum hardware compared to the total number of available qubits in the quantum annealer. This complicates the execution of quantum jobs. More specifically, in an optimization problem, the number of qubit-qubit connections involved is typically larger than the number of physical qubit-qubit connections available in the quantum hardware.

In an optimization problem, logical relationships between variables are represented via an adjacency matrix. A nonzero entry in an adjacency matrix corresponds to a relationship between the respective qubits and a nonzero term in the quadratic polynomial. However, a logical relationship between two qubits, in quantum hardware, can only exist if they are directly connected in the hardware.

In addition to the relative scarcity of qubit-qubit connections in quantum computing systems, different quantum computing systems have different physical topologies. In other words, the qubits of different quantum computing systems are connected in different manners. While quantum simulators, which may be implemented in classical computing systems, may allow all of the qubits to be connected, quantum simulators are slower than physical quantum computing systems. In order to take advantage of the performance offered by quantum hardware, it is necessary to translate the logical qubits of a quantum job to physical qubits of the quantum hardware.

The process of translating logical qubit relationships to physical qubit relationships is referred to as a minor embedding operation or process. The minor embedding process, however, is not a trivial process and can significantly consume both time and computing resources.

Generally, the purpose of minor embedding is to translate the logical qubit relationships to physical qubit relationships such that qubit connection restrictions of the target quantum computing system (e.g., a quantum annealer) are satisfied while also creating enough redundancy for representing a logical qubit with a desired error tolerance.

When an adjacency matrix is dense and has qubits that are on par with or about the same as the number of qubits offered by the quantum annealer, a problem often arises in that the logical connections represented in the adjacency matrix cannot be mapped to the target quantum computing system. Thus, the target quantum computing system is not compatible with the quantum job. However, this information is not available and is acquired only after attempting to perform the minor embedding process.

In other words, determining whether an adjacency matrix or quantum job can be supported by a target quantum computing system, the minor embedding process must be performed for that target quantum computing system. Unfortunately, the minor embedding process is, in itself, an optimization problem that requires time to execute and is solved using various heuristics. Even if optimizations exist to make the minor embedding process more efficient, the minor embedding process must be performed for each target quantum computing system at least because the target quantum computing systems have different topologies-thus the embedding differs. This presents a scalability problem and can make the process of identifying a quantum computing system that is compatible with the quantum job both difficult and time-consuming.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1A discloses aspects of executing a quantum job;

FIG. 1B discloses aspects of a minor embedding operation that determine whether a quantum computing system is compatible with a quantum job;

FIG. 1C discloses aspects of performing a minor embedding operation;

FIG. 2 discloses aspects of orchestrating aspects of a quantum job, including aspects of identifying compatible quantum computing systems;

FIG. 3 discloses aspects of a prediction engine configured to identify quantum computing systems that are compatible with a quantum job;

FIG. 4 discloses aspects of a method for identifying quantum computing systems that are compatible with a quantum job and for orchestrating execution of the quantum job; and

FIG. 5 discloses aspects of a computing device, system, or entity.

### DETAILED DESCRIPTION OF SOME EXAMPLE EMBODIMENTS

Embodiments of the present invention generally relate to executing quantum jobs in quantum computing systems. More particularly, at least some embodiments of the invention relate to systems, hardware, software, computer-readable media, and methods for selecting a quantum annealer to execute a quantum job based on matrix density levels of the quantum jobs.

Quantum computing (hardware based) systems such as quantum annealers are capable of solving a variety of problems including optimization and combinatorial problems. These types of problems are often expressed as quadratic unconstrained binary optimization (QUBO) problems, which are a specific class of problems that can be solved using quantum annealers. These problems are often expressed as or referred to herein as a quantum job.

Once a quantum job is prepared, the quantum job may be submitted to an orchestration engine. The orchestration engine orchestrates execution of the quantum job. However, a quantum job is composed of smaller jobs that may also be orchestrated. Many of these smaller jobs are performed in classical computing systems (e.g., nodes or systems that may include processors, memory, networking hardware, etc.). Although embodiments of the invention are discussed in the context of QUBO problems, embodiments of the invention are not limited thereto.

An optimization problem may be expressed using multiple variables that are binary in nature (e.g., minimize y=−5x₁−3x₂−8x₃−6x₄+4x₁x₂+8x₁x₃+2x₂x₃+10x₃x₄). A model of the problem can also be expressed in matrix form, which is generally represented as

$${min}_{x ∈ {\{ 0 , 1 \}}^{n}} {x}^{T} Q x .$$

Generally, quantum annealing interpolates between a static problem-independent Hamiltonian for which a ground state can be efficiently prepared and a final Hamiltonian whose ground state yields a desired solution. A quantum annealing system interpolates between H₀ and H_{f} (H₀=Q). Thus, H(t)=α(t)H₀+B(t)H_{f}. In this example, H_{f} is the Hamiltonian of the problem to be solved.

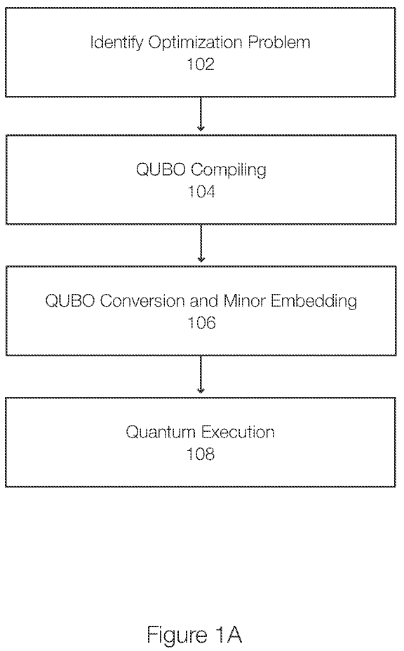

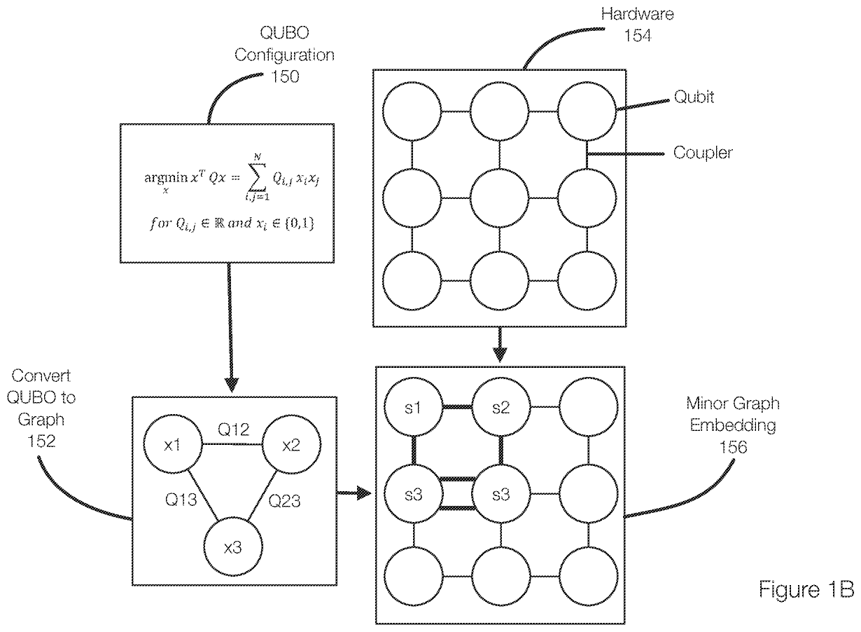

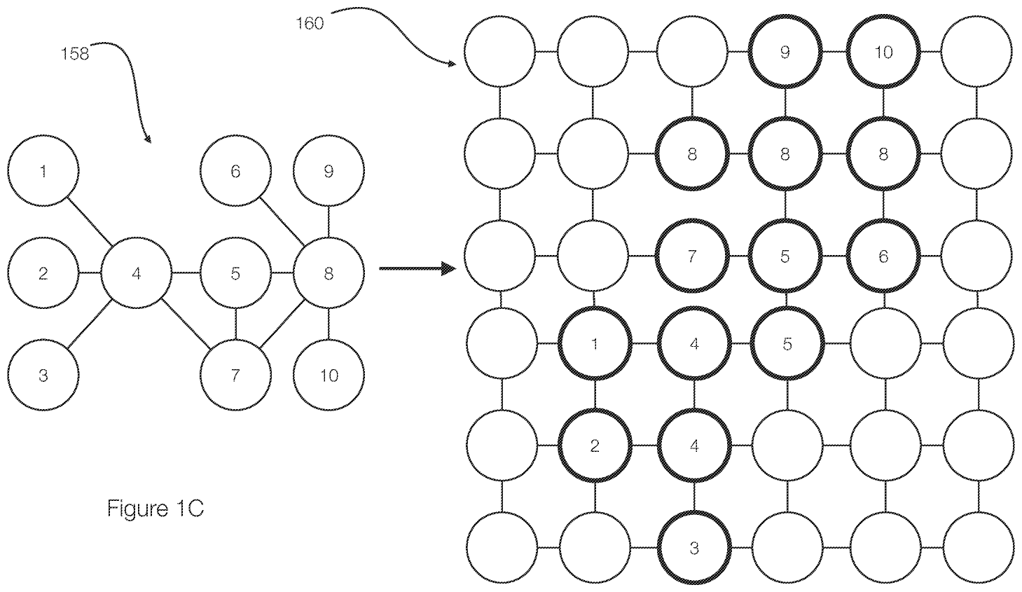

FIG. 1A discloses aspects of solving optimization problems or executing quantum jobs using classical and/or quantum computing systems (e.g., CPU, GPU, QPU). Generally, the process begins by identifying 102 a problem (e.g., optimization, combinatorial) to be solved. Identifying 102 a problem may include defining a problem instance, encoding variables, determining variables, and the like. Once the problem is defined, QUBO compiling 104 is performed. Compiling may include placing the problem or the representation of the problem into a QUBO format in preparation for submitting the quantum job (or the QUBO) to a quantum annealer.

For example, a QUBO may be defined as follows after the problem is identified and the QUBO is compiled:

$${arg min}_{x} {x}^{T} Qx = {\sum }_{i , j = 1}^{N} {Q}_{i , j} {x}_{i} {x}_{j} for {Q}_{i , j} ∈ ℝ and {x}_{i} ∈ \{ 0 , 1 \} .$$

Once the QUBO is formulated, the QUBO is converted to a graph and minor embedding 106 is performed. By way of example, minor embedding is a process of mapping the graph to the physical hardware of the quantum system. In effect, the qubits of the logical problem are mapped to the qubits of the quantum computing system.

FIG. 1B illustrates an example of converting a QUBO to a graph and performing a minor embedding operation. In this example, a QUBO 150 is converted into a graph 152. The minor embedding operation 156 is performed by mapping the graph 152 to the hardware 154 of the quantum system.

FIG. 1C further illustrates aspects of performing a minor graph embedding operation. In FIG. 1C, a graph 158 is embedded or translated to the hardware 160 of a quantum computing system such as a quantum annealer.

Aspects of quantum annealing are disclosed in Quantum Annealing for Industry Applications: Introduction and Review, Sheir Yarkoni et al 2022 Rep. Prog. Phys. 85 104001, which is incorporated by reference in its entirety.

Once the QUBO graph is mapped to the physical hardware, the quantum computing system may be initialized (set to a particular energy state) and quantum execution 108 may be performed to solve the QUBO. The solution is represented in the final state of the quantum computing system.

The minor embedding operation, as previously stated, translates logical relationships into physical relationships in order to satisfy the qubit connection restrictions of the target quantum system and to create enough redundancy for representing a logical qubit with a desired error tolerance. Performing a minor embedding operation is difficult and, in some instances, not possible, in some circumstances. The density of the QUBO matrix can impact the minor embedding process. This leads to a situation where the logical connections cannot be mapped to the target quantum computing system. In some examples of a minor embedding operation, the cost function is optimized to create artificial qubit connections at the expense of reducing the total number of qubits (i.e., the variables) that can be used. This may reduce the actual problem size the quantum computing system can handle by orders of magnitude.

Embodiments of the invention thus relate to determining whether a QUBO configuration can be executed or supported by a target quantum system without having to execute the minor embedding operation. Stated differently, embodiments of the invention are configured to identify which of the available quantum computing systems may be compatible with a particular quantum job. More specifically, embodiments of the invention may reduce the number of quantum computing systems to consider for a particular quantum job. It is possible that a quantum computing system preliminarily identified as compatible may not actually be compatible. The compatibility of a selected quantum computing system may be determined when the minor embedding operation is performed.

The minor embedding operation is a complex operation that is often an optimization problem itself. Because the minor embedding process is conventionally performed for each potential target quantum computing system, there is a significant scalability and time problem.

Embodiments of the invention relate to a prediction mechanism that estimates or predicts whether the minor embedding problem is feasible on a target quantum computing system without having to execute the minor embedding operation with respect to the target quantum computing system. The prediction mechanism is coupled with or part of an orchestration engine and is configured to aid in selecting a target quantum system for executing a quantum job. More specifically, the prediction mechanism can identify which if the available quantum computing systems are compatible or likely to be compatible with a given quantum job. This advantageously saves time by eliminating some of the quantum computing systems from consideration and by avoiding the cost of actually performing the minor embedding operation on all of the quantum computing systems. This improves both efficiency and scalability.

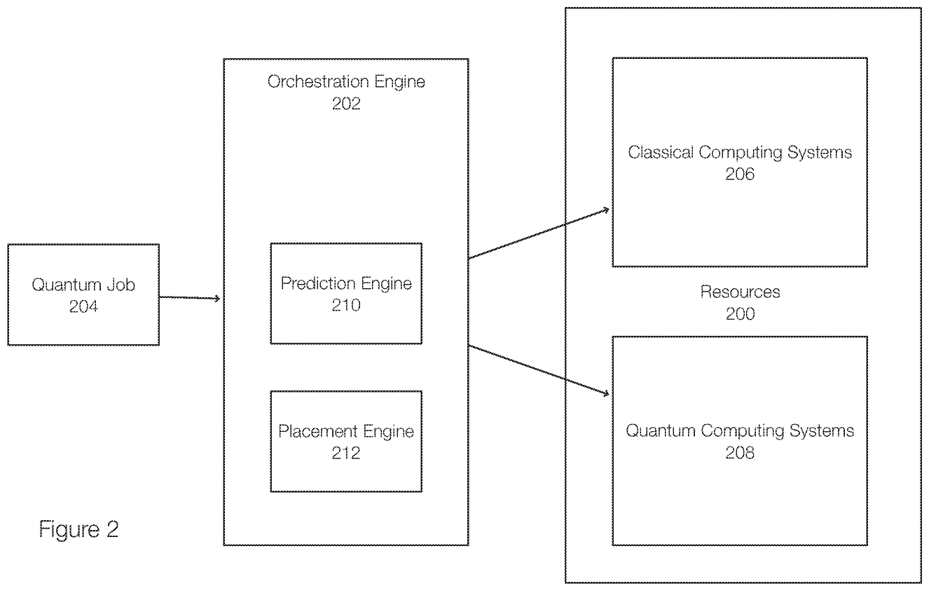

FIG. 2 discloses aspects of orchestrating quantum jobs, which includes identifying compatible quantum computing systems for the quantum jobs. FIG. 2 illustrates an orchestration engine 202 that is configured to manage or control the execution or performance of quantum jobs, such as the quantum job 204.

The orchestration engine 202 may interface with computing resources 200 such as classical computing systems 206 and quantum computing systems 208. The classical computing systems 206 may include computing devices, servers, clusters, real machines, virtual machines, containers, or the like. The classical computing systems 206 may also include virtual quantum systems. The quantum computing systems 208 may include real quantum hardware such as quantum processing units, quantum annealers, or the like.

In one example, the orchestration engine 202 receives the quantum job 204, which may be placed in a job queue and the orchestration engine 202 is configured to orchestrate aspects of performing the quantum job 204. For example, a quantum job may include various smaller jobs. For example, the quantum job may include a compilation job, a conversion to graph form job, a minor embedding job, a quantum computing system initialization job, and quantum job execution.

A placement engine 212 included in the orchestration engine 202 may be configured to place these comparatively smaller aspects of the quantum job 204 in the computing resources 200. For example, the placement engine 212 may place a compilation job (e.g., generating a QUBO) in the classical computing systems 206. The placement engine 212 may place a converting job (converting the QUBO to a graph) or a minor embedding job (embedding/mapping the graph to quantum hardware), or the like in the resources 200.

In one example, part of performing a minor embedding job may include determining which of the quantum computing systems are compatible with the quantum job 204. The orchestration engine 202 may also include a prediction engine 210 that is configured to determine whether a minor embedding operation will be successful or feasible with respect to each of multiple quantum computing systems available in the resources 200. This advantageously eliminates the need to actually perform the minor embedding operation (which may fail) with respect to all of the quantum computing systems. In fact, the prediction engine 210 may reduce the number of minor embedding operations to one minor embedding operation. This may substantially improve performance.

More specifically, because the quantum hardware of a first quantum annealer is different from the hardware of a second quantum annealer, the minor embedding operation is conventionally performed for both quantum annealers. The prediction engine 210, in contrast, may estimate or infer whether the minor embedding operation can be feasibly performed in the first of second quantum annealers without having to perform the minor embedding process in each of the quantum annealers. Rather, if the prediction engine determines that both are compatible with the quantum job, either may be selected and used to execute the quantum job. This allows the minor embedding operation to be performed a single time in the context of the selected quantum annealer.

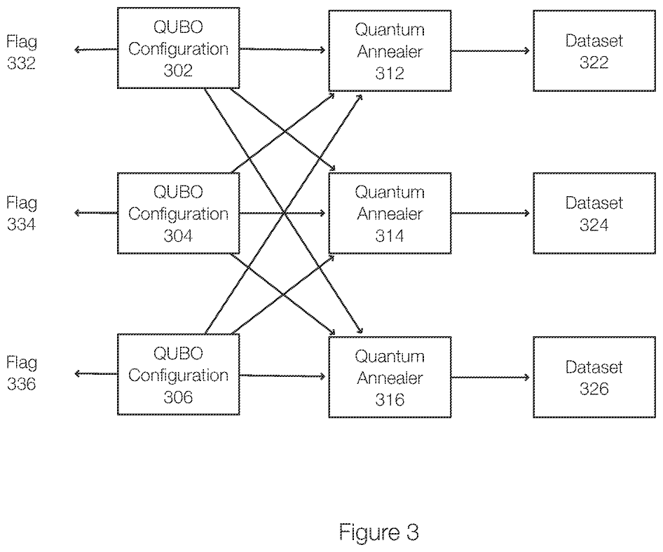

FIG. 3 discloses aspects of predicting whether a minor embedding operation can be performed or is feasible on a target quantum annealer. FIG. 3 illustrates various QUBO configurations, represented by QUBO configurations 302, 304, and 306. FIG. 3 also illustrates multiple quantum annealers, illustrated by quantum annealers 312, 314, and 316. The number of QUBO configurations and the number of quantum annealers do not need to be equal. In fact, the number of QUBO configurations is likely to be much larger in the context of training a classification machine learning model such as the prediction engine.

The QUBO configurations 302, 304, and 306 may include matrices with various densities. The density is

$$\frac{number of non - zero matrix entries}{number of total matrix entries} .$$

Next, a minor embedding operation is performed at each of the available quantum annealers. More specifically, FIG. 3 illustrates that a minor embedding operation is performed for each of the QUBO configurations 302, 304, and 306 with respect to each of the quantum annealers 312, 314, and 316. The embedding operations may also be performed multiple times with different parameterizations. The minor embedding operations may be placed in classical computing systems by the orchestration engine.

Flags, represented by the flags 332, 334, and 336 are generated for each QUBO configuration and/or each parameterization. The flag 332, for example, of the QUBO configuration 302 with respect to the quantum annealer 312 is set to 1 if the minor embedding problem has a feasible equivalent graph (e.g., is successful) and 0 if the minor embedding problem cannot be solved. The QUBO configuration 302 may be associated with other flags for other quantum annealers.

This process of performing minor embedding operations generates a dataset, represented as the datasets 322, 324, and 326, for each of the quantum annealers. The dataset 322 for the quantum annealer 312 includes at least one entry {X, y}. In this example, X is the input QUBO configuration or matrix and y is a 1 or 0 depending on whether the flag of the embedding operation is 1 or 0. Thus, the dataset 322 may include multiple entries.

Once the datasets 322, 324, and 326 are generated, a classification machine learning model, such as the prediction engine, is trained using the datasets 322, 324, and 326 to learn a function Fᵢ, for annealer i, such that yᵢ=Fᵢ(X). In one example, a machine learning model may be generated for each quantum annealer. At inference time, a new QUBO configuration X₀ is received. The available quantum annealers are traversed and yᵢ=Fᵢ(X₀) is obtained as an estimate or inference of whether the minor embedding operation is possible on annealer i.

The quantum annealers whose flag yᵢ is 0 are excluded from consideration. The remaining quantum annealers are identified to the orchestration engine and considered as candidates that are likely to be compatible for the operation of performing a minor embedding job for the matrix X₀ of the corresponding quantum job.

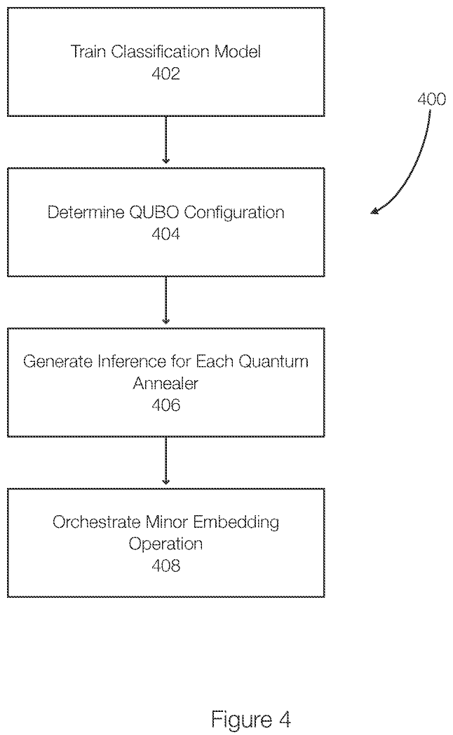

FIG. 4 discloses aspects of a method for selecting a compatible quantum annealer based on a density level of QUBO matrix or QUBO configuration. The method 400, more specifically, is configured to identify quantum annealers for which a minor embedding operation or job is feasible. After a set of quantum annealers is identified, the minor embedding operation may be placed by the orchestration engine and performed in a classical computing system.

The method 400 further illustrates aspects of selecting or identifying compatible quantum annealers. Some elements of the method 400 may be performed less frequently than other elements. For example, the classification model may be trained/updated less frequently than the elements related to generating an inference. The method 400 further illustrates a training aspect and an operational or inference aspect of selecting of identifying compatible quantum annealers for a quantum job.

In the method 400, a classification model or prediction engine is trained 402. This includes generating datasets that reflect the feasibility of embedding QUBO configurations in quantum annealers. This includes performing multiple embedding operations using multiple QUBO configurations (e.g., random QUBO configurations, historical QUBO configurations) on multiple quantum annealers to generate a flag that reflects the feasibility (1 for feasible 0 for not feasible) of performing a minor embedding operation on a given quantum annealer. Once the datasets are generated, the classification model is trained to learn a feasibility function (Fᵢ). The trained classification model or models can receive a QUBO configuration as input and, for each of multiple quantum annealers, output a feasibility estimate. This allows the orchestration engine to identify the quantum annealers for the current quantum job.

Once trained, the orchestration engine may begin operation. In FIG. 4, the orchestration engine may receive a quantum job and determine 404 a QUBO configuration for the quantum job, such as a matrix or a QUBO configuration. The prediction engine, which is an example of a classification model, may receive the QUBO configuration as input and may generate an inference for each of one or more target quantum annealers. More specifically, the prediction engine may include models that may output a flag for each of the target quantum annealers. This narrows the set of target quantum annealers to those that are likely to be compatible with the quantum job being orchestrated.

The orchestration engine can place the quantum job (or more specifically the minor embedding operation) with a classical computing system (e.g., a node) that has available resources and that can perform the minor embedding operation. Thus, the orchestration engine orchestrates execution or performance 408 of the minor embedding operation 408 at the appropriate time during the overall execution or orchestration of the quantum job. Thus, the orchestration engine may further orchestrate additional aspects of the quantum job, such as placing the quantum job with one of the compatible quantum annealers after the minor embedding operation is performed and the quantum job is ready for execution at the quantum annealer.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods, processes, and operations, are defined as being computer-implemented.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, operations which may include, but are not limited to, quantum job operations, quantum job orchestration operations, minor embedding operations, prediction operations, feasibility operations, compilation operations, QUBO execution related operations, or the like. More generally, the scope of the invention embraces any operating environment in which the disclosed concepts may be useful.

New and/or modified data collected and/or generated in connection with some embodiments, may be stored in a data protection environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to service read, write, delete, backup, restore, and/or cloning, operations initiated by one or more clients or other elements of the operating environment.

Example cloud computing environments, which may or may not be public, include storage environments that may provide data functionality. Another example of a cloud computing environment is one in which processing, data protection, and other services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients or nodes that are capable of collecting, modifying, and creating, data. As such, a particular client or node may employ, or otherwise be associated with, one or more instances of each of one or more applications that perform such operations with respect to data. Such clients or nodes may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data system components such as databases, storage servers, storage volumes (LUNs), storage disks, replication services, backup servers, restore servers, backup clients, and restore clients, for example, may likewise take the form of software, physical machines or virtual machines (VM), though no particular component implementation is required for any embodiment.

It is noted with respect to the disclosed methods, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments of the invention. These are presented only by way of example and are not intended to limit the scope of the invention in any way.

Embodiment 1. A method comprising: receiving a quantum job at an orchestration engine, identifying a minor embedding job that is part of executing the quantum job, identifying, by a prediction engine, quantum computing systems that are compatible with the minor embedding job, executing the minor embedding job in a classical computing system, and placing the quantum job at a particular quantum computing system selected from the identified quantum computing systems.

Embodiment 2. The method of embodiment 1, further comprising generating an inference by inputting the minor embedding job to the prediction engine for each of a plurality of quantum computing systems, wherein the inference indicates which of the plurality of quantum computing system are compatible with the minor embedding job and included in the identified quantum computing systems.

Embodiment 3. The method of embodiment 1 and/or 2, wherein the minor embedding job comprises a matrix and wherein the quantum computing systems comprise quantum annealers, further comprising identifying the compatible quantum computing systems based on a learned relationship between a matrix density of the matrix and hardware configurations of the quantum computing systems.

Embodiment 4. The method of embodiment 1, 2, and/or 3, further wherein the prediction engine is trained to classify the quantum computing systems that are compatible with the minor embedding job.

Embodiment 5. The method of embodiment 1, 2, 3, and/or 4, therein the classification machine learning model is trained by executing multiple minor embedding jobs on each of multiple quantum computing systems.

Embodiment 6. The method of embodiment 1, 2, 3, 4, and/or 5, further comprising generating a dataset for each of the quantum computing systems, wherein the prediction engine learns a function Fᵢ such that a flag (y) is inferred for an input embedding job (X₀) such that yᵢ=Fᵢ(X₀), wherein the prediction engine comprises a classification machine learning model.

Embodiment 7. The method of embodiment 1, 2, 3, 4, 5, and/or 6, further comprising placing the embedding job at a node selected from a plurality of classical computing systems based on resource availability at the classical computing systems.

Embodiment 8. The method of embodiment 1, 2, 3, 4, 5, 6, and/or 7, further comprising selecting the particular quantum computing system based on inferences of the prediction engine.

Embodiment 9. The method of embodiment 1, 2, 3, 4, 5, 6, 7, and/or 8, further comprising excluding quantum computing systems that are not compatible with the minor embedding job from consideration by the orchestration engine for the quantum job.

Embodiment 10. The method of embodiment 1, 2, 3, 4, 5, 6, 7, 8, and/or 9, further comprising identifying the compatible quantum computing systems without performing a minor embedding operation at each of the quantum computing systems.

Embodiment 11 A system, comprising hardware and/or software, operable to perform any of the operations, methods, or processes, or any portion of any of these, disclosed herein.

Embodiment 12 A non-transitory storage medium having stored therein instructions that are executable by one or more hardware processors to perform operations comprising the operations of any one or more of embodiments 1-10.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general-purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

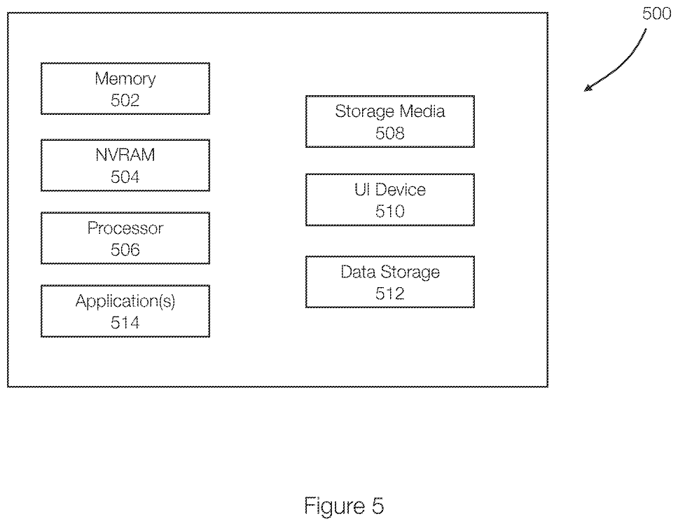

With reference briefly now to FIG. 5, any one or more of the entities disclosed, or implied, by the Figures and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 5.

In the example of FIG. 5, the physical computing device 5 includes a memory 5 which may include one, some, or all, of random-access memory (RAM), non-volatile memory (NVM) 504 such as NVRAM for example, read-only memory (ROM), and persistent memory, one or more hardware processors 506, non-transitory storage media 508, UI device 510, and data storage 512. One or more of the memory components 502 of the physical computing device 500 may take the form of solid-state device (SSD) storage. As well, one or more applications 514 may be provided that comprise instructions executable by one or more hardware processors 506 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The device 500 is representative of classical computing systems, nodes, servers, clusters, virtual computers, or the like or combination thereof. The device 500 may also implement a virtual quantum system in a classical system.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
receiving a quantum job at an orchestration engine;
identifying a minor embedding job that is part of executing the quantum job;
identifying, by a prediction engine, quantum computing systems that are compatible with the minor embedding job;
executing the minor embedding job in a classical computing system; and
placing the quantum job at a particular quantum computing system selected from the identified quantum computing systems.

2. The method of claim 1, further comprising generating an inference by inputting the minor embedding job to the prediction engine for each of a plurality of quantum computing systems, wherein the inference indicates which of the plurality of quantum computing system are compatible with the minor embedding job and included in the identified quantum computing systems.

3. The method of claim 2, wherein the minor embedding job comprises a matrix and wherein the quantum computing systems comprise quantum annealers, further comprising identifying the compatible quantum computing systems based on a learned relationship between a matrix density of the matrix and hardware configurations of the quantum computing systems.

4. The method of claim 1, wherein the prediction engine is trained to classify the quantum computing systems that are compatible with the minor embedding job.

5. The method of claim 4, wherein the classification machine learning model is trained by executing multiple minor embedding jobs on each of multiple quantum computing systems.

6. The method of claim 5, further comprising generating a dataset for each of the quantum computing systems, wherein the prediction engine learns a function Fᵢ such that a flag (y) is inferred for an input embedding job (X₀) such that yᵢ=Fᵢ(X₀), wherein the prediction engine comprises a classification machine learning model.

7. The method of claim 1, further comprising placing the embedding job at a node selected from a plurality of classical computing systems based on resource availability at the classical computing systems.

8. The method of claim 1, further comprising selecting the particular quantum computing system based on inferences of the prediction engine.

9. The method of claim 8, further comprising excluding quantum computing systems that are not compatible with the minor embedding job from consideration by the orchestration engine for the quantum job.

10. The method of claim 1, further comprising identifying the compatible quantum computing systems without performing a minor embedding operation at each of the quantum computing systems.

11. A non-transitory storage medium having stored therein instructions that are executable by one or more hardware processors to perform operations comprising:
receiving a quantum job at an orchestration engine;
identifying a minor embedding job that is part of executing the quantum job;
identifying, by a prediction engine, quantum computing systems that are compatible with the minor embedding job;
executing the minor embedding job in a classical computing system; and
placing the quantum job at a particular quantum computing system selected from the identified quantum computing systems.

12. The non-transitory storage medium of claim 11, further comprising generating an inference by inputting the minor embedding job to the prediction engine for each of a plurality of quantum computing systems, wherein the inference indicates which of the plurality of quantum computing system are compatible with the minor embedding job and included in the identified quantum computing systems.

13. The non-transitory storage medium of claim 12, wherein the minor embedding job comprises a matrix and wherein the quantum computing systems comprise quantum annealers, further comprising identifying the compatible quantum computing systems based on a learned relationship between a matrix density of the matrix and hardware configurations of the quantum computing systems.

14. The non-transitory storage medium of claim 11, further wherein the prediction engine is trained to classify the quantum computing systems that are compatible with the minor embedding job.

15. The non-transitory storage medium of claim 14, further wherein the classification machine learning model is trained by executing multiple minor embedding jobs on each of multiple quantum computing systems.

16. The non-transitory storage medium of claim 15, further comprising generating a dataset for each of the quantum computing systems, wherein the prediction engine learns a function Fᵢ such that a flag (y) is inferred for an input embedding job (X₀) such that yᵢ=Fᵢ(X₀), wherein the prediction engine comprises a classification machine learning model.

17. The non-transitory storage medium of claim 11, further comprising placing the embedding job at a node selected from a plurality of classical computing systems based on resource availability at the classical computing systems.

18. The non-transitory storage medium of claim 11, further comprising selecting the particular quantum computing system based on inferences of the prediction engine.

19. The non-transitory storage medium of claim 18, further comprising excluding quantum computing systems that are not compatible with the minor embedding job from consideration by the orchestration engine for the quantum job.

20. The non-transitory storage medium of claim 11, further comprising identifying the compatible quantum computing systems without performing a minor embedding operation at each of the quantum computing systems.
